(19) United States
(12) Patent Application Publication
(10) Pub. No.: US 2011/0285591 A1
(43) Pub. Date: Nov. 24, 2011

(54) CORRELATING CONTEXTUAL DATA AND POSITION DATA TO IMPROVE LOCATION BASED SERVICES

(75) Inventor: Yoon Kean Wong, Redwood City, CA (US)

(73) Assignee: Palm, Inc.

(21) Appl. No.: 12/783,360

(22) Filed: May 19, 2010

(51) Int. Cl. G01S 3/02

(52) U.S. Cl. 342/451

(57) ABSTRACT

A computer system for correcting position fixes received from a mobile computing device comprises a database and one or more computer server computers. The database is configured to store position fixes and corrected positions received from a plurality of mobile computing devices via wireless communication. The one or more server computers are configured to receive a position fix from a mobile computing device, to generate a corrected position from the database based on the position fix, and to send the corrected position to the mobile computing device.

### BACKGROUND

Some mobile computing devices calculate position fixes for use with location based services, such as mapping programs, turn-by-turn navigation programs, etc. In some environments, such as indoors, in parking structures, or in cities with tall buildings, position fixes may be inaccurate or less precise position calculation methods may be used. Further, while electronic map coordinates, such as data regarding points of interest, streets, etc., is available for many outdoor, public locations, such map coordinates are not readily available for indoor locations, college or corporate campuses, etc.

### BRIEF DESCRIPTION OF THE DRAWINGS

FIG. 1 is a perspective view of a mobile computing device, according to an exemplary embodiment.

FIG. 2 is a front view of the mobile computing device of FIG. 1 in an extended configuration, according to an exemplary embodiment.

FIG. 3 is a back view of the mobile computing device of FIG. 1 in an extended configuration, according to an exemplary embodiment.

FIG. 4 is a side view of the mobile computing device of FIG. 1 in an extended configuration, according to an exemplary embodiment

FIG. 5 is a block diagram of the mobile computing device of FIG. 1, according to an exemplary embodiment.

FIG. 6 is a schematic diagram of a computer system for correcting position fixes received from a mobile computing device, according to an exemplary embodiment.

FIG. 7 is a flowchart of a method of correcting position fixes, according to an exemplary embodiment.

FIG. 8 is a schematic diagram of a computer system for building a database using data from a plurality of mobile computing devices, according to an exemplary embodiment.

FIG. 9 is a flowchart of a method of building and querying a database using data from a plurality of mobile computing devices, according to an exemplary embodiment.

FIG. 10 is a flowchart of a method of generating a map database of specific places and position data for the specific places, according to an exemplary embodiment.

### DETAILED DESCRIPTION

Some embodiments described herein can generate a map of indoor locations, colleges and/or corporate campuses, enabling a large number of location based services, such as providing directions and commercial applications. Some embodiments described herein can provide a corrected or more accurate position of a place of interest. Some embodiments can use crowdsourcing of data from many mobile computing devices to build map databases quickly, automatically, and even dynamically. Some embodiments can use crowdsourcing of data to identify better routes. These and other features and embodiments will be described herein below.

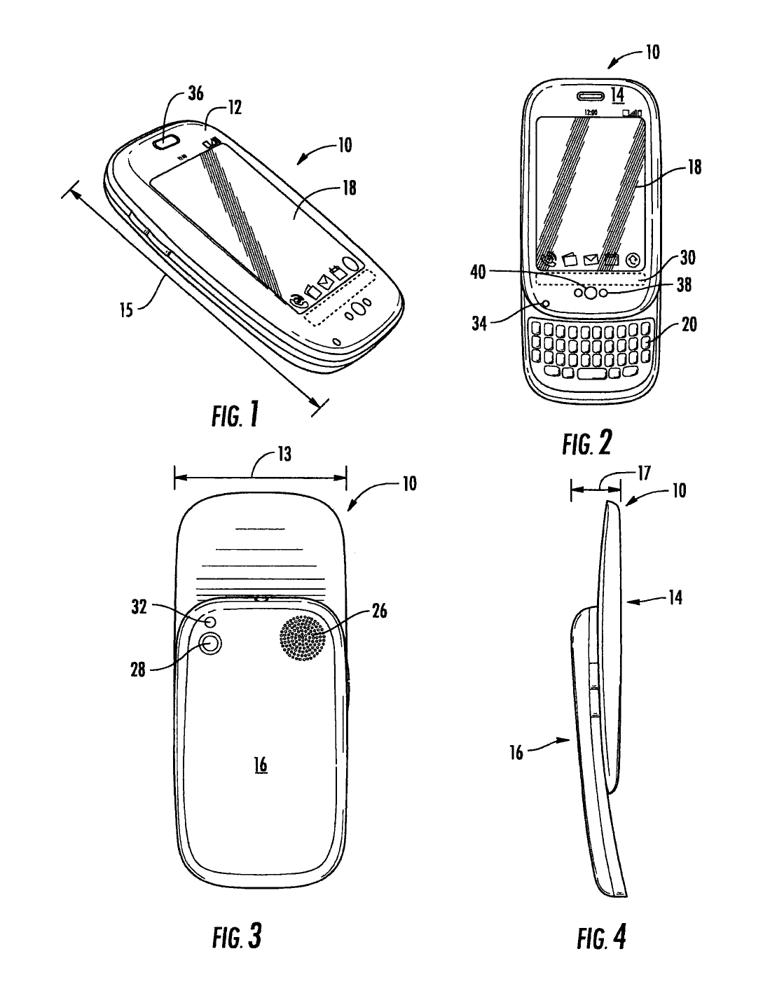

Referring to FIGS. 1-4, a mobile device 10 is shown. The teachings herein can be applied to device 10 or to other electronic devices (e.g., a desktop computer), such as mobile computing devices (e.g., a laptop computer) or handheld computing devices, such as a personal digital assistant (PDA), smartphone, mobile telephone, personal navigation device, handheld digital camera, handheld relative navigation device, etc. According to one embodiment, device 10 may be a smartphone, which is a combination mobile telephone and handheld computer having PDA functionality. PDA functionality can comprise one or more personal information management applications (e.g., including personal data applications such as email, calendar, contacts, etc.), database functions, word processing, spreadsheets, voice memo recording, Global Positioning System (GPS) functionality, etc. Device 10 may be configured to synchronize (e.g., two-way file synchronization) personal information from these applications with a computer (e.g., a desktop, laptop, server, etc.). Synchronization establishes consistency among data from device 10 to another computer (and vice-versa) and may further include continuous harmonization of the data over time. Device 10 may be further configured to receive and operate additional applications provided to device 10 after manufacture, e.g., via wired or wireless download (such as from an “application store” operable on remote server computers), Secure Digital card, etc.

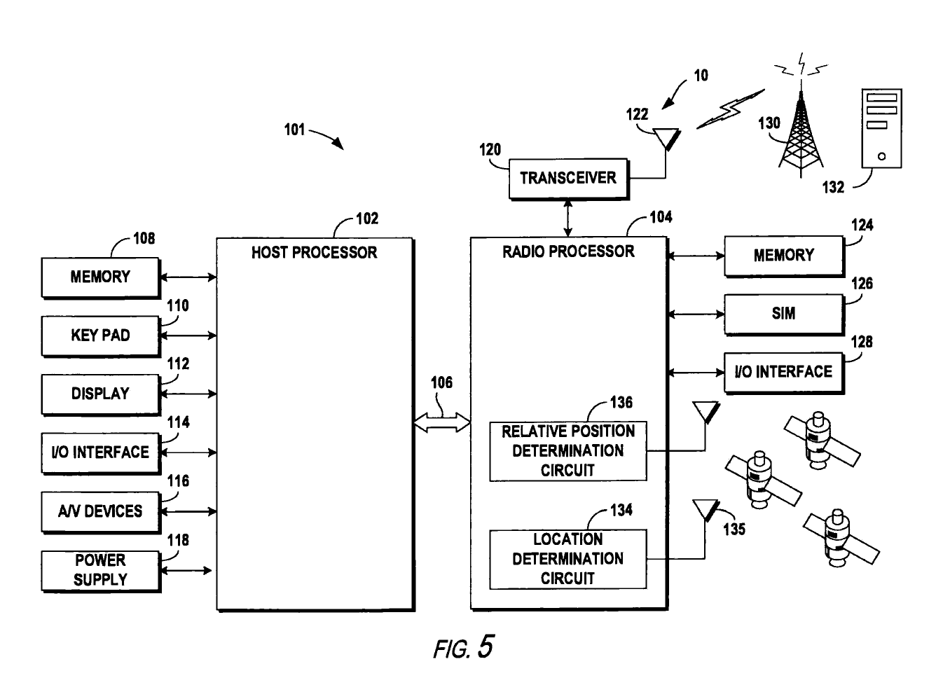

As shown in FIGS. 1-4, device 10 includes a housing 12 and a front 14 and a back 16. Device 10 further comprises a display 18 and a user input device 20 (e.g., a QWERTY keyboard, buttons, touch screen, microphone for speech recognition engine, etc.). Display 18 may comprise a touch screen display in order to provide user input to a processor 102 (see FIG. 5) to control functions, such as to select options displayed on display 18, enter text input to device 10, or enter other types of input. Display 18 also provides images (e.g., a geographic map, application icons, a web browser, etc.) that are displayed and may be viewed by users of device 10. User input device 20 can provide similar inputs as those of touch screen display 18. An input button 40 may be provided on front 14 and may be configured to perform pre-programmed functions. Device 10 can further comprise a speaker 26, a stylus (not shown) to assist the user in making selections on display 18, a camera 28, a camera flash 32, a microphone 34, and an earpiece 36. Display 18 may comprise a capacitive touch screen, a mutual capacitance touch screen, a self capacitance touch screen, a resistive touch screen, a touch screen using cameras and light such as a surface multi-touch screen, proximity sensors, or other touch screen technologies. Display 18 may be configured to receive inputs from finger touches at a plurality of locations on display 18 at the same time. Display 18 may be configured to receive a finger swipe or other directional input, which may be interpreted by a processing circuit to control certain functions distinct from a single touch input. Further, a gesture area 30 may be provided adjacent (e.g., below, above, to a side, etc.) or be incorporated into display 18 to receive various gestures as inputs, including taps, swipes, drags, flips, pinches, and so on, including multiple touch and multiple swipe commands (e.g., to zoom and/or pan an image such as a geographic map). One or more indicator areas 38 (e.g., lights, etc.) may be provided to indicate that a gesture has been received from a user.

According to an exemplary embodiment, housing 12 is configured to hold a screen such as display 18 in a fixed or movable (e.g., slidable, rotatable, hinged, etc.) relationship above a user input device such as user input device 20 in a substantially parallel or same plane, or in a different plane. The fixed relationship embodiment excludes a hinged or movable relationship between the screen and the user input device (e.g., a plurality of keys.

Device 10 may be a handheld computer, which is a computer small enough to be carried in a hand of a user, comprising such devices as typical mobile telephones and personal digital assistants, but excluding typical laptop computers and tablet PCs. The various input devices and other components of device 10 as described below may be positioned anywhere on device 10 (e.g., the front surface shown in FIG. 2, the rear surface shown in FIG. 3, the side surfaces as shown in FIG. 4, etc.). Furthermore, various components such as a keyboard etc. may be retractable to slide in and out from a portion of device 10 to be revealed along any of the sides of device 10, etc. For example, as shown in FIGS. 2-4, front 14 may be slidably adjustable relative to back 16 to reveal input device 20, such that in a retracted configuration (see FIG. 1) input device 20 is not visible, and in an extended configuration (see FIGS. 2-4) input device 20 is visible.

According to various exemplary embodiments, housing 12 may be any size, shape, and have a variety of length, width, thickness, and volume dimensions. For example, width 13 may be no more than about 200 millimeters (mm), 100 mm, 85 mm, or 65 mm, or alternatively, at least about 30 mm, 50 mm, or 55 mm. Length 15 may be no more than about 200 mm, 150 mm, 135 mm, or 125 mm, or alternatively, at least about 70 mm or 100 mm. Thickness 17 may be no more than about 150 mm, 50 mm, 25 mm, or 15 mm, or alternatively, at least about 10 mm, 15 mm, or 50 mm. The volume of housing 12 may be no more than about 2500 cubic centimeters (cc) or 1500 cc, or alternatively, at least about 1000 cc or 600 cc.

Device 10 may provide voice communications or telephony functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, etc.

In addition to voice communications functionality, device 10 may be configured to provide data communications functionality in accordance with different types of cellular radiotelephone systems. Examples of cellular radiotelephone systems offering data communications services may include GSM with General Packet Radio Service (GPRS) systems (GSM/GPRS), CDMA/1×RTT systems, Enhanced Data Rates for Global Evolution (EDGE) systems, Evolution Data Only or Evolution Data Optimized (EV-DO) systems, Long Term Evolution (LTE) systems, etc.

Device 10 may be configured to provide voice and/or data communications functionality in accordance with different types of wireless network systems. Examples of wireless network systems may include a wireless local area network (WLAN) system, wireless metropolitan area network (WMAN) system, wireless wide area network (WWAN) system, and so forth. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and so forth.

Device 10 may be configured to perform data communications in accordance with different types of shorter range wireless systems, such as a wireless personal area network (PAN) system. One example of a suitable wireless PAN system offering data communication services may include a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, etc.

As shown in the embodiment of FIG. 5, device 10 may comprise a processing circuit 101 having a dual processor architecture including a host processor 102 and a radio processor 104 (e.g., a base band processor or modem). The host processor 102 and the radio processor 104 may be configured to communicate with each other using interfaces 106 such as one or more universal serial bus (USB) interfaces, micro-USB interfaces, universal asynchronous receiver-transmitter (UART) interfaces, general purpose input/output (GPIO) interfaces, control/status lines, control/data lines, shared memory, and so forth.

The host processor 102 may be responsible for executing various software programs such as application programs and system programs to provide computing and processing operations for device 10. The radio processor 104 may be responsible for performing various voice and data communications operations for device 10 such as transmitting and receiving voice and data information over one or more wireless communications channels. Although embodiments of the dual processor architecture may be described as comprising the host processor 102 and the radio processor 104 for purposes of illustration, the dual processor architecture of device 10 may comprise additional processors, may be implemented as a dual- or multi-core chip with both host processor 102 and radio processor 104 on a single chip, etc.

In various embodiments, the host processor 102 may be implemented as a host central processing unit (CPU) using any suitable processor or logic device, such as a general purpose processor. The host processor 102 may comprise, or be implemented as, a chip multiprocessor (CMP), dedicated processor, embedded processor, media processor, input/output (I/O) processor, co-processor, a field programmable gate array (FPGA), a programmable logic device (PLD), or other processing device in alternative embodiments. In an exemplary embodiment, host processor 102 is an OMAP2, such as an OMAP2431 processor, manufactured by Texas Instruments, Inc.

The host processor 102 may be configured to provide processing or computing resources to device 10. For example, the host processor 102 may be responsible for executing various software programs such as application programs and system programs to provide computing and processing operations for device 10. Examples of application programs may include, for example, a telephone application, voicemail application, e-mail application, instant message (IM) application, short message service (SMS) application, multimedia message service (MMS) application, web browser application, personal information manager (PIM) application, contact management application, calendar application, scheduling application, task management application, word processing application, spreadsheet application, database application, video player application, audio player application, multimedia player application, digital camera application, video camera application, media management application, a gaming application, and so forth. The application software may provide a graphical user interface (GUI) to communicate information between device 10 and a user.

System programs assist in the running of the computer system. System programs may be directly responsible for controlling, integrating, and managing the individual hardware components of the computer system. Examples of system programs may include, for example, an operating system (OS), device drivers, programming tools, utility programs, software libraries, an application programming interface (API), graphical user interface (GUI), a username/password protection program, and so forth. Device 10 may utilize any suitable OS in accordance with the described embodiments such as a Palm webOS, Palm OS®, Palm OS® Cobalt, Microsoft® Windows OS, Microsoft Windows® CE, Microsoft Pocket PC, Microsoft Windows Mobile, Symbian OS™, Embedix OS, Linux, Binary Run-time Environment for Wireless (BREW) OS, JavaOS, a Wireless Application Protocol (WAP) OS, etc.

Device 10 may comprise a memory 108 coupled to the host processor 102 and a memory 124 coupled to the radio processor 104. In various embodiments, memories 108, 124 may be configured to store one or more software programs to be executed by the host processor 102 and/or radio processor 104. The memory 108 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (RAM), dynamic RAM (DRAM), read-only memory (ROM), flash memory, or any other type of media suitable for storing information.

Although the memory 108 may be shown as being separate from the host processor 102 for purposes of illustration, in various embodiments some portion or the entire memory 108 may be included on the same integrated circuit as the host processor 102. Alternatively, some portion or the entire memory 108 may be disposed on an integrated circuit or other medium (e.g., hard disk drive) external to the integrated circuit of host processor 102. In various embodiments, device 10 may comprise an expansion slot to support a multimedia and/or memory card, for example.

Device 10 may comprise a user input device 110 coupled to the host processor 102. The user input device 110 may comprise, for example, a QWERTY and/or alphanumeric key layout and an integrated number dial pad. Device 10 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad, an alphanumeric keypad, and so forth.

The host processor 102 may be coupled to a display 112. The display 112 may comprise any suitable visual interface for displaying content to a user of device 10. For example, the display 112 may be implemented by a liquid crystal display (LCD) such as a touch-sensitive color (e.g., 16-bit color) thin-film transistor (TFT) LCD screen. In some embodiments, the touch-sensitive LCD may be used with a stylus and/or a handwriting recognizer program.

Device 10 may comprise an input/output (I/O) interface 114 coupled to the host processor 102. The I/O interface 114 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a local personal computer (PC). In various implementations, device 10 may be configured to transfer and/or synchronize information with the local computer system.

The host processor 102 may be coupled to various audio/video (A/V) devices 116 that support A/V capability of device 10. Examples of A/V devices 116 may include, for example, a microphone, one or more speakers, an audio port to connect an audio headset, an audio coder/decoder (codec), an audio player, a digital camera, a video camera, a video codec, a video player, and so forth.

The host processor 102 may be coupled to a power supply 118 configured to supply and manage power to the elements of device 10. In various embodiments, the power supply 118 may be implemented by a rechargeable battery, such as a removable and rechargeable lithium ion battery to provide direct current (DC) power, and/or an alternating current (AC) adapter to draw power from a standard AC main power supply.

As mentioned above, the radio processor 104 may perform voice and/or data communication operations for device 10. For example, the radio processor 104 may be configured to communicate voice information and/or data information over one or more assigned frequency bands of a wireless communication channel. In various embodiments, the radio processor 104 may be implemented as a communications processor using any suitable processor or logic device, such as a modem processor or base band processor. The radio processor 104 may comprise, or be implemented as, a digital signal processor (DSP), media access control (MAC) processor, or any other type of communications processor in accordance with the described embodiments. Radio processor 104 may be any of a plurality of modems manufactured by Qualcomm, Inc. or other manufacturers.

In various embodiments, the radio processor 104 may perform analog and/or digital base band operations for device 10. For example, the radio processor 104 may perform digital-to-analog conversion (DAC), analog-to-digital conversion (ADC), modulation, demodulation, encoding, decoding, encryption, decryption, and so forth.

Device 10 may comprise a transceiver module 120 coupled to the radio processor 104. The transceiver module 120 may comprise one or more transceivers configured to communicate using different types of protocols, communication ranges, operating power requirements, RF sub-bands, information types (e.g., voice or data), use scenarios, applications, and so forth. In various embodiments, the transceiver module 120 may comprise one or more transceivers configured to support voice communication for a cellular radiotelephone system such as a GSM, UMTS, CDMA, and/or LTE system. The transceiver module 120 also may comprise one or more transceivers configured to perform data communications in accordance with one or more wireless communications protocols such as WWAN protocols (e.g., GSM/GPRS protocols, CDMA/1×RTT protocols, EDGE protocols, EV-DO protocols, EV-DV protocols, HSDPA protocols, Long-Term Evolution protocols, etc.), WLAN protocols (e.g., IEEE 802.11a/b/g/n, IEEE 802.16, IEEE 802.20, etc.), PAN protocols, Infrared protocols, Bluetooth protocols, EMI protocols including passive or active RFID protocols, and so forth.

The transceiver module 120 may be implemented using one or more chips as desired for a given implementation. Although the transceiver module 120 may be shown as being separate from and external to the radio processor 104 for purposes of illustration, in various embodiments some portion or the entire transceiver module 120 may be included on the same integrated circuit as the radio processor 104.

Device 10 may comprise an antenna system 122 for transmitting and/or receiving electrical signals. As shown, the antenna system 122 may be coupled to the radio processor 104 through the transceiver module 120. The antenna system 122 may comprise or be implemented as one or more internal antennas and/or external antennas.

Device 10 may comprise a subscriber identity module (SIM) 126 coupled to the radio processor 104. The SIM 126 may comprise, for example, a removable or non-removable smart card configured to encrypt voice and data transmissions and to store user-specific data for allowing a voice or data communications network to identify and authenticate the user. The SIM 126 also may store data such as personal settings specific to the user.

Device 10 may comprise an I/O interface 128 coupled to the radio processor 104. The I/O interface 128 may comprise one or more I/O devices to enable wired (e.g., serial, cable, etc.) and/or wireless (e.g., WiFi, short range, etc.) communication between device 10 and one or more external computer systems.

In various embodiments, device 10 may comprise location or position determination capabilities, such as location determination circuit 134. Device 10 may employ one or more absolute position determination techniques including, for example, Global Positioning System (GPS) techniques, Cell Global Identity (CGI) techniques, CGI including timing advance (TA) techniques, Assisted GPS (AGPS) techniques, hybrid techniques, etc. A Wi-Fi Positioning System may be used as another type of absolute positioning system, such as one provided by Skyhook Wireless, Inc., Boston, Mass. For example, an absolute positioning circuit may be configured to collect Wi-Fi identifier data from a plurality of nearby Wi-Fi access points (e.g., any wireless transceiver communicating according to an IEEE 802.11x protocol) and retrieve a latitude/longitude or other absolute position from a database by looking up the Wi-Fi access point identifiers received in the position of interest. In another example, a Wi-Fi access point may be configured to transmit its absolute position and device 10 may be configured to determine that its absolute position is the position of the Wi-Fi access point, within a predetermined error. Another type of absolute positioning system having less accuracy than GPS is a Cell-ID triangulation positioning system, such as one provided by Telmap, Ltd., London, United Kingdom. Device 10 may further comprise a relative position determination circuit 136, as described in U.S. patent application Ser. No. 12/731,490, entitled “Mobile Computing Device having Relative Positioning Circuit,” filed Mar. 25, 2010 to Wong et al. and/or as described in U.S. Patent Pub. No. 2009/0251363 published Oct. 8, 2009 entitled “System and Method for Locating Items and Places,” both of which U.S. patent applications are expressly incorporated by reference herein in their entireties.

In various embodiments, device 10 may comprise dedicated hardware circuits or structures, or a combination of dedicated hardware and associated software, to support absolute and/or relative position determination. For example, the transceiver module 120 and the antenna system 122 may comprise GPS receiver or transceiver hardware and one or more associated antennas coupled to the radio processor 104 to support position determination.

The host processor 102 may comprise and/or implement at least one LBS (location-based service) application. In general, the LBS application may comprise any type of client application executed by the host processor 102, such as a GPS application, configured to communicate location requests (e.g., requests for position fixes) and/or location responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transit schedules, information regarding local points-of-interest (POI) such as restaurants, hotels, landmarks, and entertainment venues, and other types of LBS services in accordance with the described embodiments.

Radio processor 104 also may set request/response parameters to request and return various types of position information. Examples of request/response parameters may include current location, latitude, longitude, altitude, heading, vector information such as horizontal and vertical velocity, sector-based position location, position fix method, level of accuracy, time offset, position uncertainty, device orientation, client initialization and registration, and so forth.

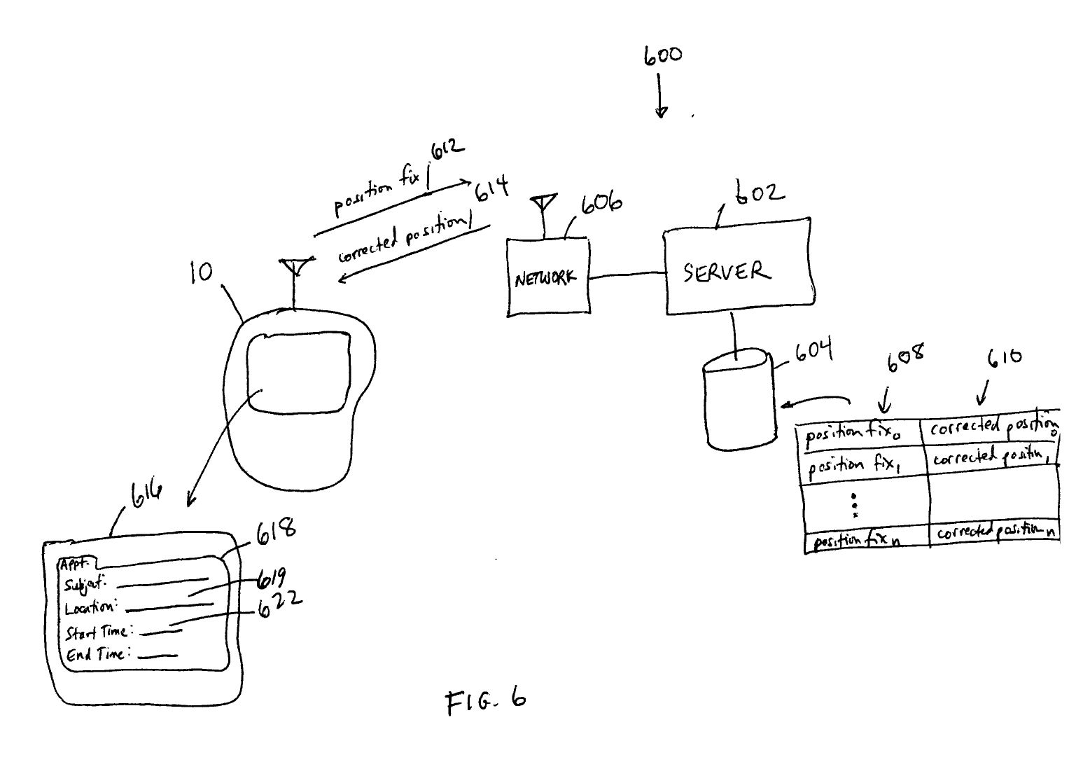

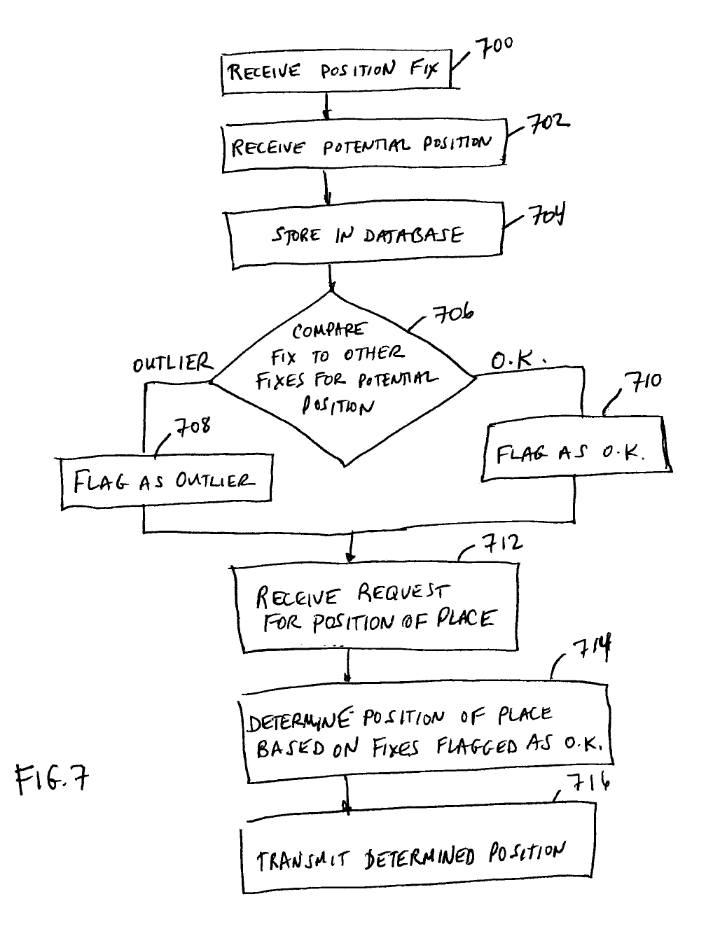

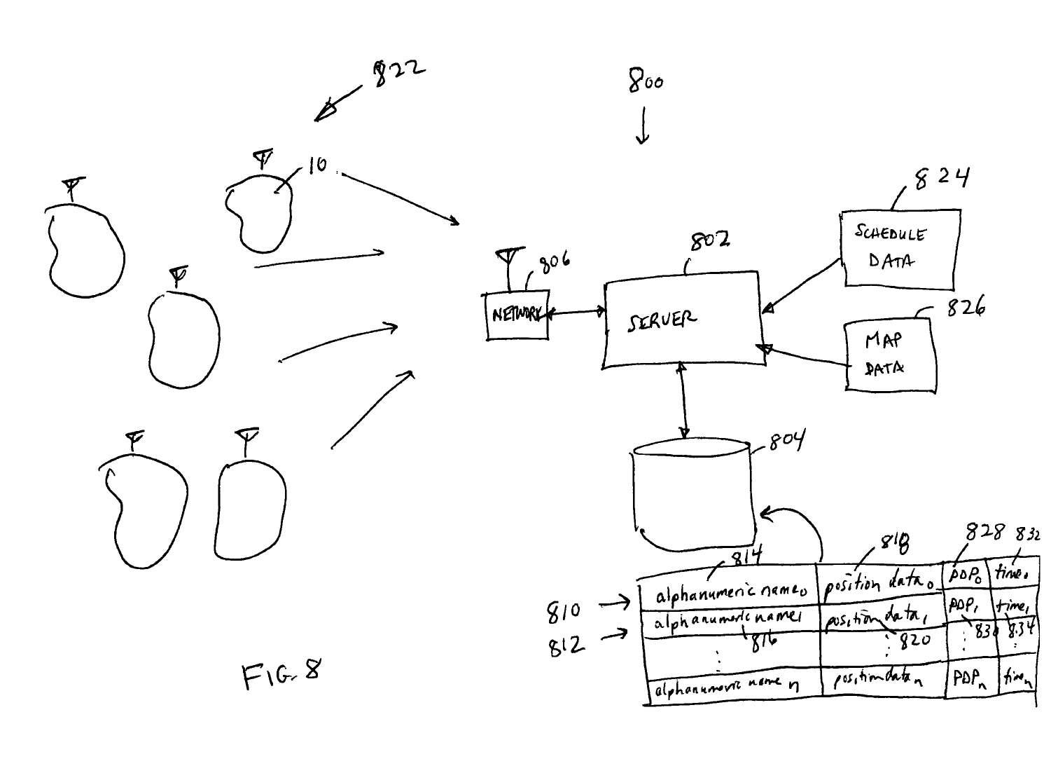

Referring now to FIG. 6, a computer system 600 for correcting position fixes received from a mobile computing device will be described. A mobile device 10 is shown in communication with system 600. In this exemplary embodiment, device 10 may be at an indoor location or at another environment in which signals from GPS satellites are spotty, noisy, or otherwise contain some level of error or inaccuracy leading to a less precise position fix. Alternatively, device 10 may be using cellular triangulation or another position determination technique or process, and a position fix calculated using the process has some degree of imprecision due to the surrounding environment, such as, the geography of the land, positioning of the buildings, time of day, or other features that may make for a noisy environment for position determination.

Noisy environments for position determination tend to be noisy in relatively deterministic ways, such that two or more devices similarly equipped and using similar determination processes will likely experience similar error vectors in position determination. In the embodiment of FIG. 6, computer system 600 is configured to correct position fixes received from mobile computing devices. Computer system 600 comprises one or more computer servers 602 and a database 604. Data messages are received from mobile device 10 via a cellular network or other wireless communication network 606. Server 602 may comprise a single computer server or multiple computer servers, such as may be the case with cloud computing. Portions of the processes described herein may be operable on one or more different computer servers at one or more different locations. Database 604 may comprise any memory of a variety of types. Database 604 is configured to store position fixes 608 and corrected position data 610, both of which may be received from a plurality of mobile computing devices via wireless communication. The corrected position data may be in latitude/longitude format or in another format, or may even be in or comprise alphanumeric data. The corrected position may represent an actual (or at least more accurate) position of a location or place of interest calculated by the server based on the position fix and some error (as determined solely from the position fix or from the position fix and knowledge about the equipment and/or time and/or process used to get the position fix).

In one exemplary embodiment, server 602 may be configured to receive a position fix 612 from device 10, generate a corrected position 610 based on looking up the position fix in database 604, and sending the corrected position 614 to mobile device 10. A position fix is position data calculated or generated by the mobile computing device for its position. For example, if mobile device 10 is in parking space number 4 in a covered parking lot, and it calculates its position fix using GPS or cellular triangulation techniques, an error created by the environment may cause device 10 to calculate a position fix associated with parking space number 7. Assuming a predetermined database 604 of position fixes and corrected positions, which may be generated as described herein, server 602 may be configured to receive the position fix from device 10, look up the corrected position 610, and return the corrected position to device 10 to notify device 10 that it is in fact in parking spot number 4. The corrected position can take any of a variety of forms, such as an alphanumeric name (which may comprise both alphabetic and numeric characters, all alpha characters, all numerical characters, and/or other ASCII symbols), a latitude/longitude or other coordinate system, a relative position to another position or place, etc.

According to another embodiment, server 602 may be configured to receive an identifier of a position determination process used by device 10 to calculate position fix 612. The position determination process may represent a type of position determination circuit and/or the method used by the circuit to determine position. Characteristics of the position determination process may include the type of position determination (e.g., GPS, cell ID, triangulation, relative), error, conditions, time of day (a “time” or “time stamp”), etc. The identifier may be a code, number, or other message which may be transmitted with position fix 612 or otherwise communicated to server 602. Server 602 may be configured to generate the corrected position based further on the identifier. For example, if device 10 uses GPS signals to calculate its position fix for its parking lot number, an error due to a noisy GPS environment may put the position fix at parking spot number 7, whereas an error attributable to a noisy cellular triangulation environment may put the position fix at parking lot number 9. Server 602 may be configured to use the identifier of the position determination process to select the appropriate corrected position.

According to another embodiment, server 602 may be configured to populate database 604 based on data indicative of a potential position of mobile computing device 10. Data indicative of a potential position of device 10 may comprise any data having some informed basis to represent where device 10 is located. For example, device 10 in this embodiment may operate a calendar application configured to provide a calendar appointment screen 616, the screen comprising a calendar appointment record 618 comprising such fields as a subject, location, start time and end time. A location 619 at a time 622 may provide data indicative of a potential position of device 10. Server 602 may receive the calendar appointment data 619, 622 and use the data as an assumed or potential location of where device 10 will be at a specific time. Server 602 may then receive a position fix 612 at a time at which device 10 is scheduled to be at location 619. Server 602 may be configured to populate database 604 (by storing data and/or otherwise generating a record in database 604) with the data indicative of a potential position of device 10 and the position data 612. The location 619 may be in a position where a position determination process has error. Therefore, the assumed location 619 may be stored as the correct position 610 (or in a record associated with the correct position 610) in a record keyed to position fix 612. Corrected position 610 may be either stored in the database 604, or dynamically calculated or derived in response to some event (such as a position fix 612), and returned as corrected position 614. It is understood that device 10 may not be at the specified location due to a change in plans, etc. Server 602 may compensate for this possibility in any number of ways. According to one embodiment, server 602 receives position fixes from a large number of devices 10 and over a period of time from the same devices. Server 602 may be configured to filter out one or more position fixes based on their relationship to other position fixes for the same location. Server 602 may “crowd source” data from a crowd or a large number of devices 10 (such as more than 10 devices, more than 100 devices, etc.) and to average position fixes from the crowdsourced data, filter out outlier data, etc. Outlier data is data that is numerically distant or otherwise deviates markedly from other members of the sample. Server 602 may weight the position fixes 612 from a large number of devices using factors such as time, error, accuracy, type of position determination, etc., and use those weighting factors to generate an average or range or set of position fixes that are correlated with location 619.

Referring now to FIG. 7, a method of correcting position fixes received from a mobile computing device will be described. At a step 700, server 602 is configured to receive a position fix from a mobile computing device 10. At a step 702, a potential position of device 10 is received. The potential position may be received from mobile computing device 10 as described above. Alternatively, a potential position may be received from another source, such from a schedule of expected locations of device 10 (e.g., a curriculum for a student at a college indicating classrooms and times), or from another source. The potential position may or may not be the actual position, but will be based on some information or knowledge about where a device 10 is or should be at a particular time. At a step 704, the position fix and potential position are stored in a database. At a step 706, server 602 is configured to compare a received position fix and potential position to other fixes for the potential position. The comparison can comprise filtering, such as determining whether the position fix is within a predetermined distance of other fixes for the potential position that had been previously received by server 602 from mobile devices or from other sources. At a step 708, in the case where the position fix falls outside the predetermined threshold, it is flagged as an outlier. At a step 710, in the case where the position fix falls within a threshold, it is flagged as an acceptable data point. At a step 712, server 602 is configured to receive a request for a position of a place. The request may comprise an alphanumeric or textual identifier of the place to be found, or may be queried as a way point along a route. At a step 714, server 602 is configured to determine the position of the place based on position fixes flagged as OK. At a step 716, the determined position is transmitted to the device requesting the position, such as a mobile device 10.

Referring now to FIG. 8, a computer system for a building a database using data from a plurality of mobile computing devices will be described. A database 804 stores a plurality of records 810, 812, each record comprising an alphanumeric position name, 814, 816 and corresponding position data 818, 820. A server 802 is configured to receive position fixes calculated by a plurality of mobile computing devices 822, to determine alphanumeric position names for the position fixes and to store the position fixes and alphanumeric position names as new records in database 804.

According to one embodiment, crowdsourcing of position data is used to identify positions of specific places or locations. One benefit of crowdsourcing this information is that outliers can easily be filtered out. For example, if a mobile device 10 has a calendar appointment location field indicating an alphanumeric name for a specific place, and device 10 sends a position fix and alphanumeric name to server 802 at the prescribed time, server 802 may store this data as a record in database 804. Having received some number of similar messages from others of mobile devices 822, such as more than 10, more than 100, more than 1000, etc., server 802 has sufficient information to determine an accurate position of the location associated with the alphanumeric name. For example, while some small percentage of crowdsourced devices 822 may not have gone to the location at the prescribed time, server 802 may be configured to determine the location based on the reminder of crowdsource devices 822 which did go to the location that described time, as determined by a sufficiently large sample of devices 822 having a same or similar position fix reported at the prescribed time. Exemplary locations may include a specific room, building, or other place on a corporate or university campus. In another embodiment, mobile device 10 may be used via an internet connection to order movie tickets via an application such as Fandango, which will cause a calendar appointment or event and an alphanumeric or textual location to appear in a location field of a calendar event on device 10. A location check can then be done at the prescribed time to identify the location of device 10. In this embodiment, the location of the movie theatre can be determined without requiring predetermined map data. Thus, a potential or supposed location of device 10 based on some contextual data such as a calendar appointment may be correlated with a position fix by server 802, wherein the position fixes are crowdsourced and the position fix itself may benefit from the crowdsourcing. Embodiments described herein may be particularly advantageous in private locations, such as collegiate and corporate campuses; however, public locations may also benefit from the embodiments described herein.

While server 802 may receive the alphanumeric position names for the position fixes from the mobile computing devices 802 as described above, in an alternative embodiment, server 802 may be configured to receive or determine alphanumeric position names from schedule data 824, map data 826, or another source. Schedule data 824 may comprise any schedule data file that device 10 or a person operating device 10 has planned to follow. Schedule data 824 may be provided to server 802 by being uploaded from another server computer, received via an Internet website, or received from device 10. Similarly, map data 826 may comprise a data file having predetermined alphanumeric position names and corresponding position data that may be useful to server 802 in extrapolating, estimating, or otherwise determining locations nearby locations of the map data based on position fixes from mobile device 10. For example, if a location for room 212 in Building A is known from map data 826, server 802 may be configured to infer the location of Room 211 or 213 to be nearby Room 212.

As described above, alphanumeric position names may be based on calendar entries in calendar applications. Alternatively, alphanumeric position names may be derived from other contextual hints from other applications operating on the mobile computing devices. Context data may be data about the context in which the mobile device is operating when a position fix is being calculated, such as the time of day, the person operating the device, data derived from an internet browser history which may be associated with a calendar appointment, or any other data from other applications operable on device 10. Context data may also be the results of image recognition on captured photos or video, results of audio recognition on captured audio, results of detection of other nearby wireless devices, implied location by monitoring of communications (e.g. a Twitter message saying “I am at Starbucks”), results of coupling or communicating with accessories or systems at a known location (e.g. a uniquely-identifiable charger or docking station at a known location, or interaction with a payment terminal or kiosk), etc. A contextual hint may be any context data that may provide hints, suggestions, or indications of the actual position of the mobile computing device.

Referring again to FIG. 8, data records 810 and 812 may further comprise a data field indicating a type of position determination process used by one or more of devices 822 to acquire position fixes or position data. As shown, the position determination process indicators 828, 830 may be stored along with a corresponding alphanumeric name and position data. Each record in database 804 may further comprise a time 832, 834 indicating a time that the position data was generated or calculated or determined by the device which generated the record. The data may further comprise an error for the position fix (not shown) which may be calculated by the server or global device 10 based on known limitations of the position determination process and characteristics of the environment in which the position determination process was implemented. Server 802 may be configured to use one or more of this additional data 828, 830, 832, 834 and error to determine an actual location for a particular alphanumeric name when such is requested by a mobile device or other computing device. For example, server 802 may adjust, flag, or otherwise process data entries identified in the position determination process identifiers as being captured via GPS, by using data on GPS satellite orbits, such as from the International GNSS Service, to adjust for expected interference due to obstructions, multi-path, or other causes for error in the position data. Thereby, the accuracy of the returned corrected position data may be increased.

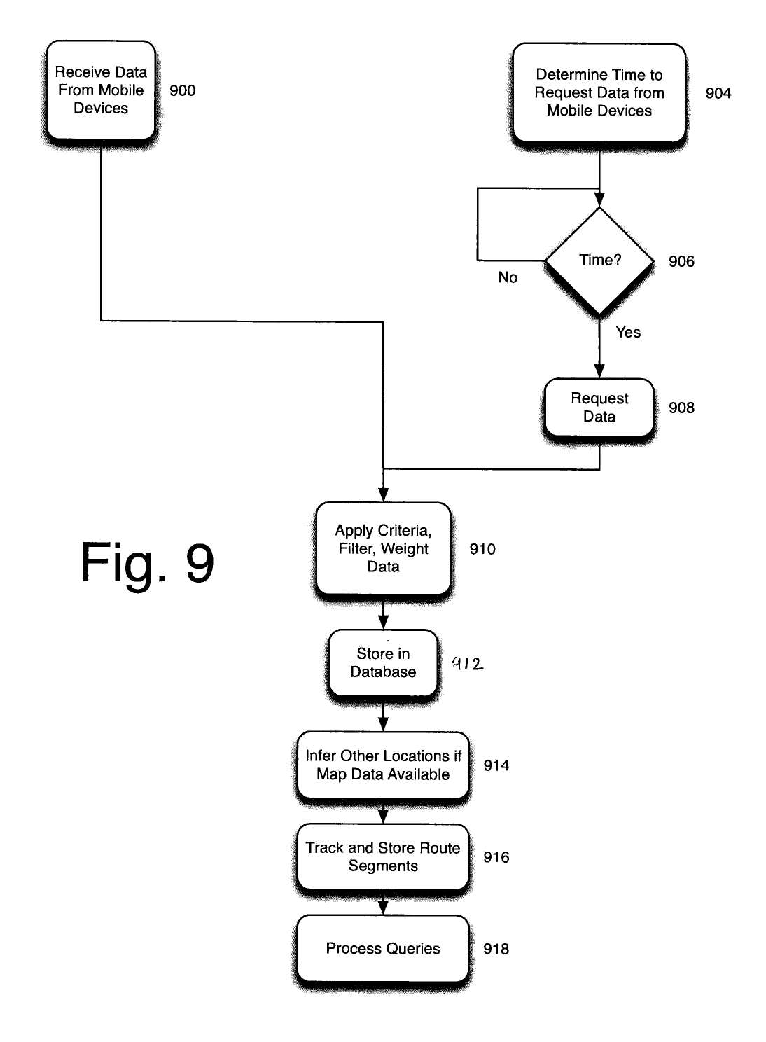

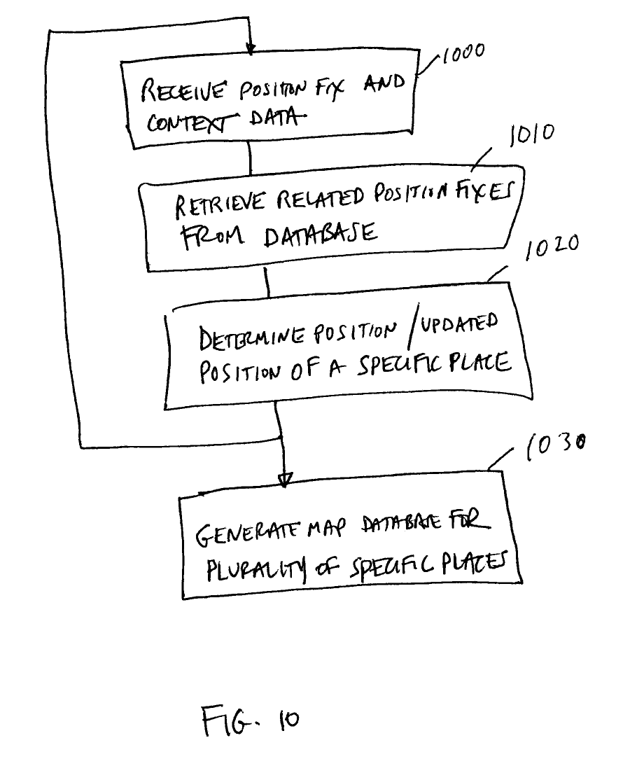

Referring now to FIG. 9, an exemplary method of building a database using crowdsourced data will be described. In this embodiment, a university campus will be used as an exemplary site to be mapped, though the method may be applied to any public or private geographic areas. At a step 900, data is received from a plurality of mobile devices. A server may be accessible by any mobile device via the Internet, or a private server accessible via a virtual private network or other secure, credentialed network. The server acts as an aggregation point for data from different mobile devices and other sources. At step 900, mobile clients post information up to the server, which then stores the data in a database. The information may comprise one or more of a name for the location, a location fix (e.g., latitude/longitude/altitude or other coordinate system or method to identify location), an identifier of the type of equipment and/or method used to get the location fix (some are more accurate or trustable than others), an error for the location fix, a time stamp, and/or other data from mobile devices 10.

Devices 10 may send data to the server on their own accord, without being prompted by the server, which may be based on certain criteria determined by an application operating on the mobile devices. If a communication is client-initiated, the message may comprise information indicating a current position fix, time of day, and indication of what the position is supposed to be, such as an alphanumeric or textual description of the position, and perhaps other data. The device may send the data in response to a user input or it may be sent automatically, at predetermined times during the day, at times indicated by a schedule or curriculum data file stored locally on device 10, or otherwise without requiring user input.

At step 904, the server or mobile device is configured to determine whether it is a time to request or generate position fix and other data at a mobile device. The time to request or generate data may be periodic or may be based on some criteria or some data known about the expected location of mobile device 10. For example, either the server or the mobile device may operate an application that comprises a curriculum or other schedule for a person using the mobile device which may comprise data indicating rooms that the person should be in at specific times of the day. When the time of day is a predetermined time into a lecture, such as 10 minutes or 20 minutes, device 10 wakes up and sends its location and other data. Alternatively, the server may determine that the time has come to request data and data is requested at step 908 from the mobile device. According to one embodiment, if many students in a college are sending data to the server about the coordinates of their lecture rooms in a university, it would not take long to have a database of the geographic location of every lecture on the campus versus its name. Once the database is created, many uses for this information are available.

At a step 910, the server is configured to process the data in any of a number of ways. For example, criteria can be applied, such as a criteria to require a minimum number of samples for a particular location before the server concludes that a trusted or reliable position fix has been determined for that location, such that the position fix would be made available for query and use. In another example, filtering may be used to verify whether newly received position fixes are generally in the same area as previously received location fixes for a particular place. For example, if a student skipped a class, the position fix of their dormitory would not pollute the main set of data for the classroom they were supposed to be in. According to another example, a weighting algorithm or time-based filter may be applied to accommodate movement of locations. For example, if a professor moved his office from one location to another, the server would be able to determine over time, from data regarding student visits to the professor's office, that the office has moved. In this way, a map of the campus may be dynamic and may change and improve with changes occurring on the campus. At a step 912, the database is updated with the improved data set that has been filtered, weighted and/or had other criteria applied to it.

At a step 914, the server may be configured to correlate the data received from the mobile devices with a map data file of the campus which can allow the server to infer other locations. For example, if position fixes had been received for offices 21 and 23, the server could create an assumptive location that office 22 is located between office 21 and 23, or on an opposite side of a hallway, etc. The server may be configured to parse the alphanumeric name or other data of the location in order to make the determination that a location is near other locations similarly numbered. At a step 916, the server may be configured to use a plurality of data records and/or records from the map data to track and store route segments. For example, if the server knows that a device is in Classroom A and the user's next subject is in Classroom B (based on schedule data), the server may be configured to track the position fixes along a route from Classroom A to Classroom B, for example, beginning several minutes before the end of a lecture in Classroom A. This data may be stored as a route in the database. This route may be available for query from another student via mobile device or other computing device the next time a student needs to know how to get from Classroom A to Classroom B. The server may further be configured to dynamically change routes over time to accommodate new construction and other temporary or permanent obstacles that may come in the way of certain routes.

According to another embodiment, assuming a mobile device is driving from work to home or to a restaurant, data from crowdsourced mobile devices providing their routes may be compiled and stored by the server to identify the most popular routes to get from a first point to a second point on the system of roads. The server may further store time of day information, because routes may be busier or less busy at certain times of day or times of the year, (e.g., during spring break, summer break, etc.). These routes may be then made available to other computing devices for turn by turn directions and other location-based services.

At a step 918, queries on the database or databases created may be processed. The server may respond to a query by looking at all entries and dynamically generating a likely location by applying step 910 above, or even steps 914 and 904 through 908. Alternatively, the server may have a two-stage database or a database with two portions, one comprising raw, captured data and another with a single entry for each location that is the assumed location based on the crowdsourced data received.

As shown, maps can be automatically created based on hints as to where locations are from a large number of mobile devices, focusing on physical names for locations, such as alphanumeric or textual names. Such data is difficult to get today, since surveying and other manual measurement methods have been used to create such maps for universities, corporate campuses, etc.

According to another exemplary embodiment, assuming a corporate campus or office environment, the server may use time as a hint as to the location of the mobile device during which position fixes are generated. For example, assuming the cube number of a person's office is 2.2.023, and assuming that the mobile device has periodically reported its position fix to a server, along with time stamps, the server may be configured to determine that 70% of the time has been spent at a particular location, which the server may not know. However, based on information from employee records, from an employee directly, or from a map of the office building, the server may conclude that the office number 2.2.023 corresponds to the position data received from the mobile device during the majority portion of the time at the office. The server now has a correlation of an office number with a position fix. Again, even assuming certain errors that may be attributable to position fixes in an office, such as when using GPS or cell tower triangulation or assisted GPS, since such errors are relatively deterministic, the database will store data useful to other devices employing similar position determination processes.

Errors in position determination processes may be attributable to a number of factors. For GPS, in some places, satellite signals are spotty or unavailable or low in number or suffer from multipath interference. For relative positioning circuits, which begin with an accurate GPS position but then rely on dead reckoning or other methods to find a relative position, an error attributable to the dead reckoning mechanism may increase over time. With assisted GPS, the latest ephemeris data is downloaded over a network. As the ephemeris data gets old, error increases. With cell tower triangulation, the signals are subject to geography, weather, buildings, the direction you are facing, multipath interference, etc.

Querying can happen in any number of ways. For example, if a user of a mobile device needs to know how to get to a conference room, the user can input the conference room name or the device may pull the conference room name from a location field of an appointment operated by a calendar application. This data can be sent to a server which can look up the location coordinates based on the alphanumeric name and then provide directions using coordinates or other map data.

Referring now to FIG. 10, a method of generating a map database of specific places will be described according to an exemplary embodiment. At a step 1000, one or more computer servers are programmed with computer readable instructions for receiving a position fix and contact data for the position fix from a mobile computing device. Using the position fix and context data along with the related position fixes and context data from a number of other mobile computing devices (step 1010), an updated position of a specific place can be determined (step 1020). Related position fixes and context data may comprise position fixes and context data for a same, similar or close location to an original or first position fix/context data. At step 1030, this can be repeated for a number of specific places to gather a number of data points, preferably a large number of data points, so that at a step 1030, a map database can be generated of the specific places and position data for the specific places. A specific place may be any place of interest, such as a point of interest, and may have one or more alphanumeric names associated with it.

Various embodiments disclosed herein may include or be implemented in connection with computer-readable media configured to store machine-executable instructions therein, and/or one or more modules, circuits, units, or other elements that may comprise analog and/or digital circuit components (e.g. a processor or other processing circuit) configured or arranged to perform one or more of the steps recited herein. By way of example, computer-readable media may include RAM, ROM, CD-ROM, or other optical disk storage, magnetic disk storage, flash memory, or any other medium capable of storing and providing access to desired machine-executable instructions. The use of circuit or module herein is meant to broadly encompass any one or more of discrete circuit components, analog and/or digital circuit components, integrated circuits, solid state devices and/or programmed portions of any of the foregoing, including microprocessors, microcontrollers, ASICs, programmable logic, or other electronic devices.

While the detailed drawings, specific examples and particular formulations given describe exemplary embodiments, they serve the purpose of illustration only. The hardware and software configurations shown and described may differ depending on the chosen performance characteristics and physical characteristics of the computing devices. The systems shown and described are not limited to the precise details and conditions disclosed. Furthermore, other substitutions, modifications, changes, and omissions may be made in the design, operating conditions, and arrangement of the exemplary embodiments without departing from the scope of the present disclosure as expressed in the appended claims.

What is claimed is:

1. A computer system for correcting position fixes received from a mobile computing device, comprising:
a database configured to store position fixes received from a plurality of mobile computing devices via wireless communication; and
one or more server computers configured to receive a position fix from a mobile computing device, to generate a corrected position based at least on the position fix, and to send the corrected position to the mobile computing device.

2. The computer system of claim 1, wherein the server computers are further configured to receive an identifier of a position determination process used by the mobile computing device to calculate the position fix, wherein the server computers are configured to generate the corrected position based further on the identifier.

3. The computer system of claim 1, wherein the database is configured to store an alphanumeric name for each corrected position.

4. The computer system of claim 1, wherein the server computers are configured to populate the database based on data indicative of a potential position of the mobile computing device.

5. The computer system of claim 4, wherein the data indicative of a potential position of the mobile computing device comprises data from a location field stored by a calendar application operating on the mobile computing device.

6. The computer system of claim 4, wherein the server computers are configured to compare position fixes from a plurality of mobile computing devices for a potential position of the mobile computing device and to filter out one or more of the position fixes based on their relationship to others of the position fixes.

7. A computer system for building a database using data from a plurality of mobile computing devices, comprising:
a database configured to store a plurality of records, each record comprising an alphanumeric position name and corresponding position data;
one or more server computers configured to receive position fixes from a plurality of mobile computing devices, to determine alphanumeric position names for the position fixes, and to store the position fixes and alphanumeric position names as new records in the database.

8. The computer system of claim 7, wherein the server computers are configured to determine the alphanumeric position names for the position fixes by receiving the alphanumeric position names from the mobile computing devices.

9. The computer system of claim 8, wherein the alphanumeric position names are based on calendar entries in calendar applications on the mobile computing devices.

10. The computer system of claim 8, wherein the alphanumeric position names are based on contextual hints from other applications operating on the mobile computing devices.

11. The computer system of claim 7, wherein each record further comprises one or more characteristics of a position determination process used to acquire the position data.

12. The computer system of claim 7, wherein one or more computer servers are configured to receive an indication that the position fixes were generated using a relative positioning circuit.

13. The computer system of claim 11, wherein each record further comprises a time stamp indicating a time that the position data was determined by the mobile computing device and an error for the position fix.

14. The computer system of claim 7, wherein the server computers are configured to determine the alphanumeric position names based on predetermined schedule data indicative of where the mobile computing device is scheduled to be at a particular time.

15. The computer system of claim 7, wherein the server computers are configured to filter received position fixes based on at least one of a predetermined number of samples, a relationship of a new position fix to previously received position fixes for a same or similar location, and a time-based weighting filter.

16. The computer system of claim 7, wherein the server computers are configured to determine the alphanumeric position names based on map data comprising position data nearby the position fixes received from the mobile computing devices.

17. One or more computer servers programmed with computer-readable instructions for:
receiving a position fix and context data for the position fix from a mobile computing device;
using the position fix and context data along with related position fixes and context data from a number of other mobile computing devices to determine a position or updated position of a specific place;
repeating the steps of receiving and using for a number of specific places; and
generating a map database of the specific places and position data for the specific places based on the repeating step.

18. The one or more computer servers of claim 17, wherein the context data comprises a time at which the position fix was determined by the mobile computing device.

19. The one or more computer servers of claim 17, wherein the context data comprises an alphanumeric position name stored in a calendar appointment record by a calendar application operable on the mobile computing device.

20. The one or more computer servers of claim 17, wherein the context data comprises a name of a person using the mobile computing device.

21. The one or more computer servers of claim 17, wherein the map database represents a corporate or university campus.

22. The one or more computer servers of claim 17, wherein the step of using comprises using position fix and context data from more than ten different mobile computing devices, and the number of specific places in the map database is more than ten specific places.

23. The one or more computer servers of claim 17, wherein the step of using comprises removing outlier data points from the determination of the position or updated position of the specific place.

24. The one or more computer servers of claim 17, further comprising receiving an indication that the position fix was generated using a relative positioning circuit.
